(19) United States
(12) Patent Application Publication
(10) Pub. No.: US 2010/0028567 A1
(43) Pub. Date: Feb. 4, 2010

(54) GLASS SHEET DEFECT DETECTION DEVICE, GLASS SHEET MANUFACTURING METHOD, GLASS SHEET, GLASS SHEET QUALITY JUDGING DEVICE, AND GLASS SHEET INSPECTION METHOD

(76) Inventors: Hidemi Suizu, Shiga (JP); Yasuhiro Nishimura, Shiga (JP); Masakazu Iwata, Shiga (JP)

Correspondence Address: WENDEROTH, LIND & PONACK, L.L.P., 1030 15th Street, N.W.,, Suite 400 East, Washington, DC, 20005-1503, US

(21) Appl. No.: 12/518,960

(22) PCT Filed: Dec. 13, 2007
(86) PCT No.: PCT/JP2007/074026

§ 371 Date: Jun. 12, 2009

(30) Foreign Application Priority Data
Dec. 14, 2006 (JP) 2006-336518

(51) Int. Cl. B32B 17/00; G01N 21/896; G06F 19/00; C03B 17/06

(52) U.S. Cl. 428/1.32; 356/239.2; 702/82; 65/29.12; 428/220

(57) ABSTRACT

A glass sheet defect detection device includes a light source and a light reception device which are placed at opposed positions so as to sandwich a glass sheet. The glass sheet has light-transparent surfaces opposed to each other in a thickness direction. The glass sheet is placed between the light source and the light reception device so that the light-transparent surfaces are inclined with respect to a light axis of an optical system of the glass sheet defect detection device at a predetermined angle. Moreover, the light reception device and the glass sheet are placed in such a positional, relationship that a focal length of a lens system of the light reception device is smaller than a distance from a light reception element of the light reception device and the glass sheet.

### TECHNICAL FIELD

The present invention relates to a defect detection device of detecting defects of a glass sheet formed from molten glass, in particular, a glass sheet mounted on a liquid crystal display device or a plasma display, a manufacturing method for a glass sheet using the defect detection device, a glass sheet obtained by the manufacturing method, and a quality judging device of evaluating defects of a glass sheet to judge the quality thereof.

### BACKGROUND ART

Along with remarkable advancement of a display device technology, technologies related to image display devices of various kinds of systems such as a liquid crystal display and a plasma display have been progressed significantly. Particularly, in large-size image display devices and the like in which a high-definition display is realized, high-level technical innovation is in progress in order to reduce a production cost and enhance an image quality. A glass sheet to be mounted on such various kinds of devices and used for displaying an image is also required to have a higher size quality and a higher precision in surface property compared with those of a conventional example. In the manufacturing of a glass sheet for a display device or the like, a glass sheet is formed using various kinds of manufacturing devices, and in any case, generally, an inorganic glass material is melted by heating, and the molten glass is homogenized and formed into a predetermined shape. At this time, due to various causes such as an insufficiently molten glass material, unintended contamination of foreign matters in a course of manufacturing, aging of a forming device, and inconveniences of temporary forming conditions, a defect such as abnormality of a surface quality may be generated in a glass sheet. Various countermeasures have been taken so as to suppress the generation of such defects in a glass sheet. However, it is difficult to completely suppress the generation of the defects, and even when the generation of defects can be suppressed to some degree, if there is no technology of distinguishing a glass sheet with a defect clearly, defective products that are supposed to be judged as failed products may be mixed with glass sheets judged to be of good quality. Thus, a technology of detecting defects of a glass sheet with good precision is becoming very important.

Under such circumstances, a number of technologies of detecting defects of a glass sheet have been proposed. For example, Patent Document 1 discloses a method of irradiating a glass sheet substrate with inspection light in an oblique direction and projecting light transmitted through the substrate onto a projection surface, and inspecting optical characteristics of the glass sheet substrate based on a projected image on the protection surface, as a method of inspecting a glass sheet substrate in a rough surface state obtained after treating a glass sheet to be mounted on a liquid crystal display device with hydrofluoric acid. Further, Patent Document 2 uses a system capable of detecting a change in an optical path length smaller than 100 nm with use of a lens that detects the retardation of light, in order to detect defects of a transparent substrate such as a glass sheet.

### Patent Document 1: JP 2003-42738 A

### Patent Document 2: JP 2006-522934 A

### DISCLOSURE OF THE INVENTION

### Problem to be Solved by the Invention

According to the inspection method of Patent Document 1, an optical amount is insufficient because the light scattering from the projection surface is also photographed, and further, an inspection with a high precision cannot be realized due to the presence of a noise from the projection surface. Further, the projected images in the vicinity of both ends of the glass sheet substrate are distorted, and a required precision may not be obtained. According to the system of Patent Document 2, though some performance is obtained, a light ray is radiated to a glass sheet in a perpendicular direction, and hence information on defects nay not be obtained sufficiently, particularly, in a glass sheet with a small thickness. Further, if an attempt is made so as to inspect a glass sheet for a display with a large area in detail, using a great amount of time for inspection the prolonged inspection time limits a manufacturing speed. Various kinds of glass sheets to be mounted on displays are frequently required to have a size for a larger area, and such glass sheets with a large area are required to be managed more strictly compared with the conventional example. On the other hand, the production cost cannot be increased compared with the conventional example due to a factor such as the prolonged inspection time. Further, along with the increased definition of an image display device, regarding the defects generated in glass sheets, defects with more minute sizes or those with sizes ignorable conventionally should be paid attention to.

An object of the present invention is to detect various defects generated inside or on a surface of a glass sheet rapidly and efficiently with a high precision and judging a quality of the glass sheet with high reproducibility in the course of the high-speed manufacturing of a glass sheet with a large area under the above-mentioned circumstances.

### Means for Solving the Problem

That is, the present invention provides a glass sheet defect detection device in which a glass sheet having light-transparent surfaces opposed to each other in a thickness direction is irradiated with a light ray from a light source, and the light ray from the glass sheet is received by a light reception device to detect defects of the glass sheet, characterized in that: the light source and the light reception device are placed with the glass sheet being interposed therebetween; the light-transparent surfaces of the glass sheet are inclined with respect to a light axis of an optical system from the light source to the light reception device; a focal length of a lens system of the light reception device is smaller than a distance from a light reception element of the light reception device to the glass sheet on the light axis; and one of the light-transparent surfaces of the glass sheet is irradiated with the light ray from the light source, and the light ray transmitted through the glass sheet is received by the light reception element through the lens system of the light reception device.

Herein, in an optical system of the device, the light axis refers to a symmetrical axis that connects the light reception device to the light source optically, and that passes through the center of the optical system of the device. Specifically, the light axis is a line that links the centers of a series of optical elements constituting the optical system from the light source to the light reception device.

Defects present on the surface (light-transparent surface) of or inside a glass sheet include not only knots, striae (or cords), and bubbles (or seeds or blisters) caused by foreign matters in the glass sheet or insufficient melting thereof, but also waves, streaks, open pores, unevenness, and scratches on the surface of the glass sheet, and the like. On the other hand, when an image of a glass sheet is formed on the light reception element of the light reception device, for example, minute foreign matters and dust adhering to the surface of the glass sheet, and the properties of very minute waves and the like on the surface of the glass sheet, which do not inherently cause a problem in the quality of the glass sheet, are recognized by the light reception device, and the information thereof becomes a noise, which may decrease the detection precision of defects and complicate the later data processing. According to the present invention, the focal length of the lens system of the light reception device is set to be smaller than the distance from the light reception element of the light reception device to the glass sheet on the light axis in such a manner that the image of the glass sheet is not formed on the light reception element of the light reception device, whereby the above-mentioned inconveniences are prevented. Further, the glass sheet, the light source, and the light reception device are placed so that the light-transparent surface of the glass sheet is inclined with respect to the light axis, whereby an optical path length of a light ray passing through the inside of the glass sheet becomes relatively large, and the information amount per unit area of a pencil of light rays transmitted through the glass sheet becomes large. Therefore, sufficient information on the defects can be obtained, particularly, even with respect to a glass sheet with a small thickness

Defects may be detected while swinging a glass sheet at an arbitrary speed and changing the inclination angle between the light-transparent surface and the light axis in a predetermined range. Alternatively, defects may be detected while moving a glass sheet at a constant speed in a direction parallel to the light-transparent surface.

In the present invention, as a light source, ones which have any of various wavelengths in a range of a UV-ray to visible light can be used. Thus, a monochromic light source or a light ray in a certain wavelength range may be used. Needless to say, general light sources such as a fluorescent lamp, and an incandescent lamp may be used, and high intensity discharge lamps (HID lamps) such as a mercury lamp, a sodium lamp and a metal halide lamp, a halogen lamp, a xenon lamp, an LED lamp, an EL lamp, an electrodeless lamp, or the like may be used.

Glass sheets that can be inspected by the glass sheet defect detection device of the present invention include various kinds of glass sheets formed in a sheet shape, such as a glass sheet to be mounted on a liquid crystal display device, a glass sheet for various kinds of filters, a cover glass of a solid imaging element such as a CCD or a CMOS, a window glass sheet of a laser diode, a window class sheet for construction, a reinforced glass sheet, or a crystallized glass sheet. Though there is no limit to the size of the glass sheet, the present invention can be more effectively utilized, particularly, as the glass sheet has a larger area during forming.

Further, the glass sheet defect detection device of the present invention can also function as various accessory facilities if required. The device can also function as a reflective mirror and a condensing lens for condensing light rays from a light source appropriately, a slit, a diffraction grating, a filter, and the like.

Further, the glass sheet defect detection device of the present invention can detect defects inside and on the surface of the glass sheet with high sensitivity and thus can perform a stable inspection, if the inclination angle of the light-transparent surface of the glass sheet with respect to the light axis is in a range of 5° to 40°.

In the case where the inclination angle of the light-transparent surface of a glass sheet with respect to a light axis is less than 5°,the optical path length of a light ray transmitted through the inside of the class sheet becomes too large, and the information amount per unit area of pencil of light rays transmitted through the glass sheet becomes too large. Therefore, a high resolving ability is required for resolving the obtained information, which may make it difficult to analyze the information sufficiently. Conversely, when the inclination angle of the light-transparent surface of a glass sheet with respect to a light axis exceeds 40°, the optical path length of a light ray transmitted through the inside of the glass sheet becomes too small, and the information amount per unit area of a pencil of light rays transmitted through the glass sheet becomes small and the change amount of light ray Intensity depending upon the shape of the surface of a glass sheet becomes small, which may make it difficult to detect minute defects on the surface of and inside the glass sheet. The lower limit of the inclination angle of the light-transparent surface of a glass sheet with respect to a light axis is preferably 6°, more preferably 7°, much more preferably 8° and most preferably 10°. The upper limit is preferably 30°, more preferably 26°, much more preferably 25°, and most preferably 20°. That is, the most preferred range of the inclination angle of the light-transparent surface of a glass sheet with respect to a light axis is in a range of 10° to 20°.

Further, the glass sheet defect detection device of the present invention may obtain at least two pieces of information simultaneously by providing a plurality of sets of the light source and the light reception device. For example, in the case of providing two sets of the light source and the light reception device, the inclination angle of the light-transparent surface of a glass sheet with respect to a light axis can be set to be always 10° in the first set of the light source and the light reception device, and the inclination angle of the light-transparent surface or a glass sheet with respect to a light axis can be set to be always 20° in the second set of the light source and the light reception device. Further, In the case of providing one set or a plurality of sets of the light source and the light reception device, the light source and the light reception device may be allowed to be operated in coordination so that the incident angle of a light ray entering a glass sheet becomes various angles.

Further, in the glass sheet defect detection device of the present invention, in addition to the above-mentioned structure, a plurality of various kinds of optical members such as various kinds of reflective mirrors and filters can be provided in appropriate places in an optical system in the device through which a light ray travels in order to miniaturize the device. This can miniaturize the entire device, and can realize the reduction in weight of the device, the enhancement of a measurement precision, and the enhancement of an operation speed and a measurement response during measurement.

Further, in the glass sheet defect detection device of the present invention, it is preferred that the light reception device include a solid imaging element or a photoelectric detector as a light reception element in addition to the above-mentioned structure, because the device has a high detection ability and can realize a stable operation.

Herein, the solid imaging element is, for example, an image sensor such as a CCD or a CMOS, and the photoelectric detector is, for example, a photoelectrical amplifier, a vacuum phototube, or a gas-filled discharge tube.

Further, when the glass sheet defect detection device of the present invention is designed so as to scan, with a light ray from a light source, sites to be inspected of a glass sheet in a direction crossing a direction in which defects are continued, the device can exhibit a high detection ability particularly with respect to the defects having a shape continued in a predetermined direction.

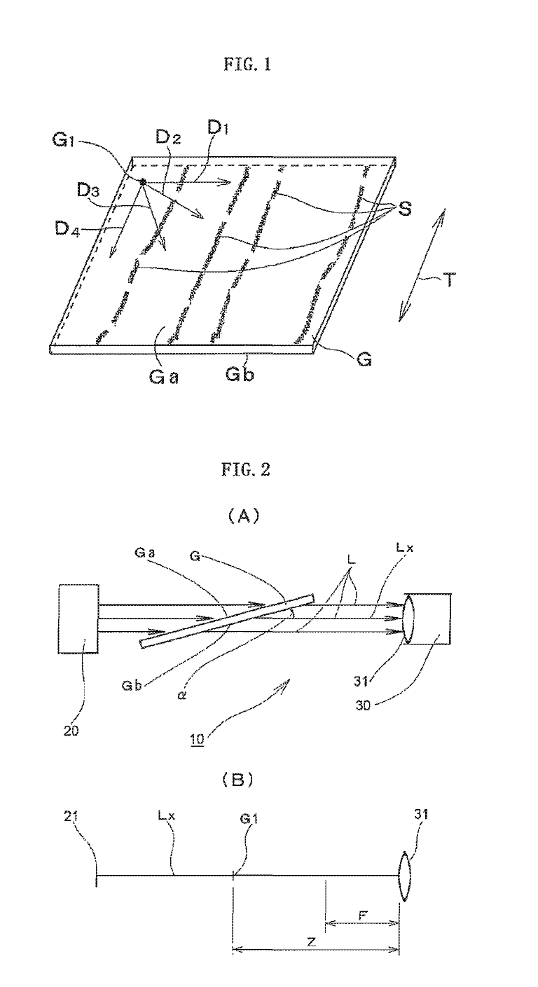

The scanning of sites to be inspected of a glass sheet in a direction crossing the direction in which defects are continued is described in detail with reference to FIG. 1. In FIG. 1, defects S continued in a predetermined direction T are present on a light-transparent surface of a glass sheet G. The defects S are striae generated due to the slight difference in homogeneity in glass, or waves and streaks caused by the unevenness on the glass surface. In the case where the defects S are scanned with a light ray from a light source, when the defects S are scanned in the same direction as the direction T in which the defects are continued, i.e. , a direction indicated by D₄, correct information cannot be detected (reference symbol G₁ denotes the position on the light axis of the glass sheet G in FIG. 1). Therefore, in the scanning direction by a light ray, it is preferred that the defects be scanned in the direction D₁ or D₂, D₃i.e., in the direction crossing the direction in which the defects are continued. In the case of the directions D₂ and D₃, it is necessary to calculate the positions of the defects from a scanning angle, and hence it is preferred to scan the defects more preferably in the direction D₁, i.e., the direction substantially perpendicular to the direction in which the defects are continued. That is, the sites to be inspected of the glass sheet are scanned preferably in a range of 3° to 90° and more preferably in a range of 80° to 90° with respect to the direction in which the defects are continued. In the case of scanning the sites to be inspected at an angle of less than 3° with respect to the direction in which the defects are continued, there is no substantial difference from the angle of 0°, i.e., the case where the sites to be inspected are scanned in parallel to the direction in which the defects are continued, and hence, an exact detection may not be performed. The continued defects are not necessarily continuous, and may be continued intermittently in a predetermined direction. The reason that the range of 0 to 90° is more preferred is as follows: various continued defects generated in a glass sheet may not be necessarily linear, and in order to exactly inspect the defects even in such a case, the scanning range of 80° to 90° is preferred in terms of enhancing the precision.

In order to detect the continued defects of the glass sheet while continuously pulling out glass sheets immediately after the forming of the glass sheets, using the glass sheet defect detection device of the present invention, it is important to obtain defect information while scanning the sites to be inspected in a direction different from the pulling-out direction of the glass sheets. This is because, in the case where the glass sheets are pulled out by continuous forming, the defects generated in the glass sheets are distributed while extending in the pulling-out direction of the glass sheets. That is, in the case of detecting the defects while continuously pulling out the glass sheets immediately after the forming of the glass sheets, “scanning of the defects in a direction crossing the direction in which the defects are continued” can be translated into “scanning of the defects in a direction different from the pulling-out forming direction of the glass sheets”. More preferably, the defects are scanned in a direction be perpendicular to the pulling-out forming direction of the glass sheets.

In the case of scanning a glass sheet by the glass sheet defect detection device of the present invention, only the glass sheet may be moved, only a light source or the like of the device may be moved, or both of them may be moved simultaneously.

Further, if the glass sheet defect detection device of the present invention has a storage device for storing information on a light ray received by a light reception device and a data display portion for displaying the information on a display, in addition to the above-mentioned structure the detected information can be recorded and displayed on the display, whereby the properties of the class sheet can be grasped exactly.

Herein, the storage device is, for example, a hard disk, a DVD, or a memory, and the display is, for example, a liquid crystal display device.

The glass sheet defect detection device of the present invention is particularly preferable for the inspecting of a thin class sheet to be mounted on a display device.

Herein, the above-mentioned display device is a liquid crystal display device, a plasma display, an SED display, or an FED display.

A glass sheet manufacturing method of the present invention is characterized in that the defects on the surface of and/or inside a glass sheet formed by a forming device after heat-melting and followed by cooling are inspected by the above-mentioned glass sheet defect detection device to judge the quality of the glass sheet.

The position of placing the glass sheet defect detection device may be the position right after the step of forming a glass sheet, the position after the step of rough cutting, the position right before packaging fin the final step, or in a plurality of arbitrary positions in a series of steps. Further, in the case of measuring the defects during the transport of the glass sheet, the glass sheet defect detection device may be provided along the transport route or the like.

As the forming device, a down draw forming device or a float forming device can be adopted. Examples of the down draw forming device include a slit down draw forming device, a roll-out down draw forming device, and an overflow down draw forming device. The float forming device is a device that flows molten glass onto molten metal such as metallic tin to form the glass.

Further, the glass sheet manufacturing method of the present invention is particularly preferable for the manufacturing of a glass sheet for a liquid crystal display and a glass sheet for a plasma display.

The glass sheet of the present invention is characterized by being manufactured by the above-mentioned glass sheet manufacturing method, and being made of alkalifree glass with a thickness of 0.7 mm or less and a maximum defect size of less than 0.1 μm.

Herein, the alkalifree glass refers to glass having a glass composition substantially free of alkali. More specifically, an alkali metal element to be incorporated in a glass composition from impurities in a glass material is permitted, but a content thereof is limited to less than 0.1% in terms of a mass percentage.

The glass sheet of the present invention can be obtained, for example, as follows. That is, an alkalifree glass sheet with a thickness of 0.7 mm or less and a maximum defect size of less than 0.1 μm is prepared as a test piece, and a plurality of alkalifree glass sheets with a thickness of 0. 7 mm or less and a maximum defect size in the vicinity of 0.1 μm (for example, 0.09 μm, 0.11 μm, etc.) are prepared as test pieces. The test pieces are measured by the glass sheet defect detection device and the measurement values thereof are accumulated. Then, the threshold value of the maximum defect size is determined as a specified value based on the accumulated data, and glass sheets in which the maximum defect size of the defects measured by the glass sheet defect detection device exceeds the above-mentioned threshold value are excluded as defective products, whereby the glass sheet of the present invention can be obtained.

Further, the glass sheet of the present invention has a maximum defect size of preferably less than 0.08 μm and more preferably less than 0.05 μm.

The defect size may be defined as the size of the defects in the scanning direction by a light ray, and the maximum defect size is the size of the largest defect among the defects. Regarding the maximum defect size, the precision of the measurement value may be verified by another inspection method, for example, the measurement by an optical microscope, an electron microscope, or the like equipped with a calibrated microgauge.

A glass sheet quality judging device according to the present invention is characterized by including: a measurement means for irradiating a glass sheet with a light ray from a light source and receiving the light ray from the glass sheet by a light reception device; a chart acquiring means for subjecting a brightness profile of an image obtained by the measurement means to Fourier transformation or wavelet transformation to obtain a processing result chart; and an algorithm processing system of evaluating defects of a glass sheet based on the processing result chart to judge quality.

Specifically, the measurement values of a brightness profile obtained by the measurement means are subjected to Fourier transformation or wavelet transformation to perform component extraction processing. Then, the resultant values are further subjected to inverse Fourier transformation or inverse wavelet transformation, and the change state of the brightness values of transmitted light is visualized. A chart illustrating a change in the obtained brightness is evaluated whether there are values outside the previously set upper limit value or lower limit value. The values that exceed the upper or lower limit value are judged as defective products, and those which do not exceed the upper or lower limit value are judged as satisfactory products, whereby the quality is judged.

Herein, in brief, Fourier transformation refers to the transformation processing of resolving a waveform graph having a complicated shape into a simplified sine wave. Fourier transformation is used herein to obtain information regarding how much of the significant waveform shape is present in a complicated chart recognized in a brightness profile before transformation by the extraction with an arbitrary extraction width from a graph in a complicated shape recognized in a brightness profile obtained as a result of the measurement. Then, by previously setting the upper and lower limit values regarding the chart after the transformation, a selection can be made.

Wavelet transformation can be applied effectively in the case of a lower period than that of Fourier transformation, i.e., with respect to a localized waveform, and is particularly effective in the case where a large period is not recognized in various kinds of defects appearing on a glass light-transparent surface.

A sampling frequency of Fourier transformation or wavelet transformation can be arbitrarily determined. Values processed by a transformation program can be displayed while being accumulated as processing data. Further, the values can be displayed as images on a display or a recording sheet.

The upper limit value or the lower limit value of the processing result chart that is finally obtained by Fourier transformation or wavelet transformation can be previously set from the outer appearance inspection level obtained by a visual inspection or the like, and the size, generation position, and the like of defect obtained by an inspection procedure of other fine defects or by an inspection means for checking a chance in a macro range. Further, or optimum set values can also be set depending upon the required performance of a glass sheet to be used.

Further, in order to specify defect of a specific size, a glass sheet having defects of a specific size is previously inspected to accumulate measurement values, and desired defects can be detected based on the pattern of the measurement values. For example, in order to set so that the maximum defect size is less than 0.1 μm, measurement values of a glass sheet having a defect size in the vicinity of 0.1 μm such as 0.09 μm or 0.11 μm are accumulated, and set values are determined based on the measurement information and used at a time of measurement requiring an actual judgment.

Further, the quality judging device of the present invention can be operated in synchronization with another processing program, and simultaneously perform various measurement operations such as measurements of the surface properties of a glass sheet and the transmittance of a glass sheet, and the analysis of the measurement values. Further, regarding the quality judgment, the standard of the quality judgment may be further fragmented, and a selection may be made from the quality in which products are used as cullet to the quality in which products are adopted as those used as an aggregate of a minute size or the like.

Further, the above-mentioned algorithm processing system may combine at least two processing result charts and make final judgment of quality based on quality results obtained from upper and lower limit values of the respective processing result charts. This enables more detailed judgment, and optimum judgment can be performed depending upon applications, types, and the like.

The quality judging device of the present invention can inspect the quality of a light-transparent surface of a glass sheet to be mounted on a display, for example.

The above-mentioned inspection may be performed in combination with the visual inspection by a human being or may be performed together with the inspection using the glass sheet defect detection device of the present invention. Further, an inspection may be conducted only with respect to a glass sheet, or an inspection may be conducted under the condition that the surface of a glass sheet is covered with a thin film or the like or the condition that a protective frame, a transportation frame, or the like is provided to the end surface of a glass sheet.

Further, an evaluation can also be made under the condition that plurality of glass sheets are laminated, if required. In this case, the information on defects caused by an interference layer to be used for obtaining a laminated state can also be detected.

### EFFECTS OF THE INVENTION

(1) As described above, in the glass sheet defect detection device of the present invention, a glass sheet, a light source, and a light reception device are placed so that the light transparent surface of a glass sheet is inclined with respect to a light axis, and the focal length of a lens system of the light reception device is set so as to be smaller than the distance from a light reception element of the light reception device to the class sheet on the light axis. Therefore, the device can obtain sufficient information on defects even with respect to a glass sheet with a particularly small thickness, and can realize a high speed defect inspection with a high precision owing to less noise mixed in the light reception device.

(2) Further, sites to be inspected of a glass sheet are scanned with a light ray from a light source in a direction crossing the direction in which the defects are continued, whereby the detection ability with a high precision can be exhibited regarding the defects such as minute striae, invisible streaks, continued foreign matters and bubbles, and a surface wave.

(3) Further, by providing a storage device for storing information on a light ray received by a light reception device and a data display portion for displaying the information on a display, a device excellent in reusability of information and in visibility is obtained, and the device exhibits a remarkably great effect in the case where a quick action is requested as an abnormal detection means in the step and when problems of the manufacturing method are analyzed.

(4) According to the glass sheet manufacturing method of the present invention, the defects on the surface of and/or inside a glass sheet formed by a forming device after heat-melting and followed by cooling are inspected using the glass sheet defect detection device and the quality is judged. Therefore, the quality of a glass sheet as a product can be judged at an early stage, which can enhance a production efficiency.

(5) The glass sheet of the present invention is made of alkalifree glass and has a thickness of 0.7 mm or less and a maximum defect size of Tess than 0.1 μm. Therefore, the glass sheet is suitable as the one to be mounted on a large image display device such as a liquid crystal display device of 40 inches or more, which is required to have a high definition. The glass sheet is a glass material having suitable excellent homogeneity.

(6) The glass sheet quality judging device of the present invention includes a measurement means for irradiating a glass sheet with a light ray from a light source and receiving the light ray from the glass sheet by a light reception device, a chart acquiring means for subjecting a brightness profile or an image obtained by the measurement means to Fourier transformation or wavelet transformation to obtain a processing result chart, and an algorithm processing system for evaluating the defects of the glass sheet based on the processing result chart to judge the quality. Therefore, the quality can be judged easily and exactly regarding the defects of the glass sheet, and further, the manufacturing system in accordance with the required quality can be established easily by changing the reference value of the defects of the processing result chart if required.

(7) The quality of the light-transparent surface of a glass sheet to be mounted on a display is inspected using the glass sheet quality judging device of the present invention, whereby an inspection can be realized in accordance with the quality standard of the quality of the light-transparent surface of the glass sheet to be mounted on a display, and the inspection time of the glass sheet to be mounted on a display is shortened and a high inspection level can be achieved.

### BEST MODE FOR CARRYING OUT THE INVENTION

Hereinafter, a glass sheet defect detection device, a glass sheet manufacturing method, a glass sheet obtained by the glass sheet manufacturing method, a glass sheet defect detection judging program, and a glass sheet inspection method according to the present invention are described by way of examples.

### Example 1

FIGS. 2 (A) and 2 (B) conceptually illustrate a glass sheet defect detection device 10 according to Example 1. The glass sheet defect detection device 10 includes a light source 20 and a light reception device 30 which are placed at opposed positions so as to sandwich a glass sheet G. The glass sheet G has light-transparent surfaces Ga, Gb opposed to each other in a thickness direction, and is placed between the light source 20 and the light reception device 30 so that the light-transparent surfaces Ga, Gb are inclined by a predetermined angle α with respect to a light axis Lx (line connecting centers of a series of optical elements constituting an optical system from the light source 20 to the light reception device 30) of the optical system of the glass sheet defect detection device 10. Further, the light reception device 30 and the glass sheet G are placed in such a positional relationship that a focal length F of a lens system 31 of the light reception device 30 is smaller than a distance Z (G1 indicates the position of the glass sheet G on the light axis Lx) from a light reception element (line sensor and the like) of the light reception device 30 to the glass sheet G.

Specifically, a thin glass sheet to be mounted on a liquid crystal display device is used as the glass sheet C to be detected, a 200 W metal halide lamp is used as the light source 20, and a 2000-pixel line sensor is placed as the light reception element of the light reception device 30. The glass sheet G is placed between the light source 20 and the light reception device 30 so that the angle α formed by the light-transparent surfaces Ga, Gb and the light axis Lx is 15°. A light ray L emitted from the metal halide lamp as the light source 20 enters the inside of the glass sheet G from one light-transparent surface Ga inclined by an angle of 15° with respect to the light axis Lx, is transmitted through the inside of the glass sheet G, and outputs from the glass sheet G through the other light-transparent surface Gb inclined by an angle of 15° with respect to the light axis Lx. Thus, the light ray L transmitted through the glass sheet G becomes transmitted light ray containing Information on the properties of the inside of the glass sheet G and the light-transparent surfaces Ga, Gb to enter the line sensor of the light reception device 30.

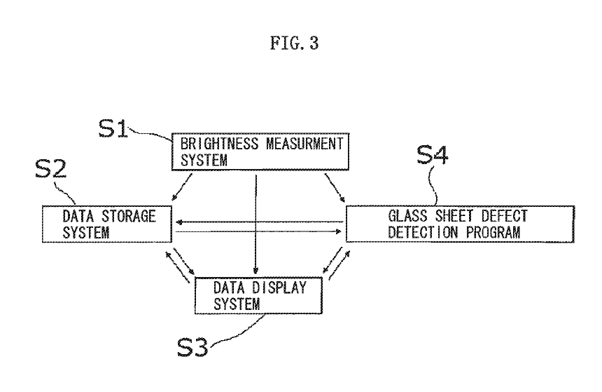

As illustrated in FIG. 3, the glass sheet defect detection device 10 of this example inputs brightness values from the light reception device 30 (line sensor) to a brightness measurement system S1 at a required frequency, and sends data to four algorithm processing systems, that is, the brightness measurement system S1, a data storage system S2, a data display system S3, and a glass sheet defect judging system S4, thereby enabling to realize various kinds of operations by the input/output of data among programs of the respective systems.

That is, in the glass sheet defect detection device 10, the brightness values of the light ray L entering the light reception device 30 (line sensor) can be accumulated, as digital data, in a random-access memory (RAM) capable of storing data in a measurement device temporarily and in a hard-disk drive (HDD) storage device that drives the data accumulated in the RAM temporarily by the data storage system S2, whereby the brightness measurement values can be stored and reused permanently. Further, by the operation of the data display system S3, the brightness values of the light ray L entering the light reception device 30 (line sensor) can be displayed in a graph two-dimensionally or three-dimensionally using other plurality of variables, invariables, or the like as parameters, or displayed as numerical data on a display of a liquid crystal display device or the like. The data display system S3 can display, for example, time-series data, type-based defect generation frequency data, a distribution display of defects generation places, and a comparison graph with respect to brightness data. Further, the brightness data can be pooled in combination with the transmittance of a glass sheet, time data, temperature, humidity and dust measurement data, and the like in synchronization with other sensors, a timer, and the like. Then, the brightness values of the light ray L entering the light reception device 30 (line sensor) are converted by an algorithm system having a program for performing wavelet transformation, and stored or displayed together with original brightness data and the like.

Hereinafter, a method of manufacturing a glass sheet by incorporating the glass sheet defect detection device 10 is described specifically regarding a method of manufacturing a thin glass sheet having an alkalifree glass composition to be mounted on an image display portion of a liquid crystal display device, and a glass sheet obtained by the method.

First, a plurality of glass materials prepared in advance so as to have an alkalifree glass composition suitable for mounting on a liquid crystal display device were weighed and mixed so as to be uniform, and stored in a mixed material storage container. Then, the mixed glass materials were charged into a glass melting furnace by a batch charger. The glass materials changed into the glass melting furnace were heated to a high temperature of 1000° C. or higher to undergo high-temperature vitrification, and had a roughly molten state. Then, the resultant glass was turned into molten glass in a homogeneous state by a homogenizing means such as a stirring device.

The homogenized molten glass is supplied to a glass sheet forming device. The glass sheet forming device includes a forming body that has a molten glass supply groove in a bucket shape opened upward in a top portion, in which both side wall top portions of the glass supply groove are used as dams for overflow, and outer surface portions of both the side walls are brought close to each other downward to be terminated at a lower end so that the cross-sectional shape thereof has a substantially wedge shape. The molten glass homogenized in the melting furnace is supplied continuously from one end of the glass supply groove to overflow ridge lines of both the side wall top portions, and flows along both the side wall outer surfaces of the forming body to be combined at the lower end in a substantially wedge shape to form one glass sheet state.

The glass sheet in a thin plate shape thus formed have a high temperature state at an early stage of forming. However, the glass sheet is cooled midway through the successive transportation by forming rolls and the like and shifts from the hot plate state to the cooled state. After the glass sheet is formed, cooled, and cooled to some degree, the glass sheet is scribed with a folding and breaking cutting device, whereby glass sheets G with a predetermined length are obtained. After that, the glass sheets G are transported one by one to a stocker by a transportation device. At some midpoint in the transportation path to the stocker, the glass sheet defect detection device 10 is placed so that the light axis Lx forms an angle of 15° with respect to the light-transparent surfaces Ga, Gb of the glass sheets G, whereby sites to be inspected of the glass sheets G are scanned in a direction perpendicular to (at an angle of 90° of) a longitudinal direction (continued direction) of the defects to measure whether the defects are recognized on the surfaces (light-transparent surfaces Ga, Gb) and inside of the glass sheets C continuously.

For example, in the case where glass sheets which have a maximum defect size of less than 0.1 μm are selected as satisfactory products, a plurality of alkalifree glass sheets with a thickness of 0.7 mm having a defect size in the vicinity of 0.1 μm such as 0.9 μm or 0.11 μm are prepared as test pieces. The test pieces are measured by the glass sheet defect detection device 10 to accumulate measurement values, and threshold values for selecting satisfactory products/defective products are determined as specified values based on the data.

Then, the measurement results of brightness input to the light reception device 30 (line sensor) by the measurement of the glass sheet G is subjected to wavelet transformation successively, and a judging operation is performed based on the specified upper limit and lower limit values (threshold values) set in advance by the above-mentioned preprocessing in an algorithm processing system judging the defects. As a result of the judgment, the glass sheets C that do not comply with the specification, i.e., the glass sheets G with a maximum defect size of 0.1 μm or more are transported to a cullet storage without being stored in the stocker for storing satisfactory products, and the glass sheets G judged not to have a problem by the judgment are transported successively to the stocker to be arranged and stored as glass sheets to be commercialized.

In the glass sheet manufactured by the above-mentioned glass sheet manufacturing a method, defects present inside and on the surface of the glass sheet are detected efficiently and judged, and hence, the glass sheet is judged exactly for the quality. Therefore, when the glass sheet is mounted on a large-scale liquid crystal display device of more than 40 inches to be used for a display, a television, or the like, the state of quality having high homogeneity and surface precision capable of allowing the performance of a high-definition liquid crystal display device to be exhibited perfectly is realized.

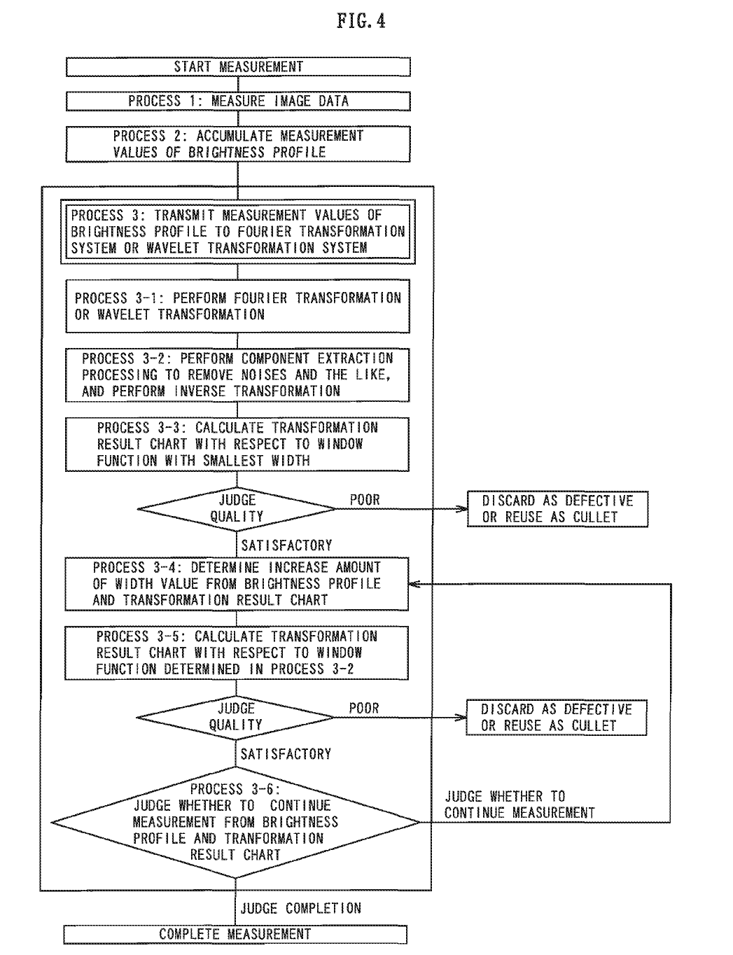

Next, a glass sheet defect detection judging program to be used for detecting, using the glass sheet defect detection device 10, the defects of a thin glass sheet to be mounted on, for example, a liquid crystal display device, a plasma display, or the like is described with reference to a flowchart in FIG. 4.

The glass sheet defect detection program starts the measurement by “START MEASUREMENT” and proceeds to a process 2 through a process 1 input under the condition that distinct electric noises and the like are removed by providing a filter to a profile of brightness values, if required. In the process 2, the required data from a RAM is stored in an HDD at a predetermined frequency by the data storage system S2 described above. Further, in the process 3, the input brightness values are subjected to Fourier transformation or wavelet transformation, whereby an operation corresponding to the glass sheet defect judging system S4 is performed.

First, in a process 3-1, Fourier transformation or wavelet transformation is performed. Then, in a process 3-2, component extraction processing is performed to remove noises and the like, and inverse Fourier transformation or inverse wavelet transformation is performed. In a process 3-3, a transformation result chart with respect to a window function with a smallest width is calculated. The obtained transformation result chart is stored by the data storage system S2, and is displayed as a graph image by the data display system S3. Then, based on the transformation result chart with respect to a window function with a smallest width, it is judged whether the result is outside of upper and lower limit values (threshold values) of the quality previously set. In the case where the result is outside of the threshold values, the glass sheet involved in the measurement is judged to be “poor”, and is used as a cullet or for another application. Then, in the case where the result is judged to be “,satisfactory”, the width value of the window function is determined from the profile of brightness values and the transformation result chart as in a process 3-4. In a process 3-5, a second transformation result chart is calculated in accordance with the width value of the window function determined in the process 3-4. The second transformation result chart thus obtained is further judged for the quality. In the case where the chart is judged to be “poor”, the glass sheet is used as a cullet or for another application in the same way as in the above-mentioned case. Then, in the case where the chart is judged to be “satisfactory”, the brightness profile and the second transformation result chart are compared in a process 3-6, whereby it is judged whether the further continued transformation is necessary. If it is judged that the further continued transformation is necessary as a result, the processing in the process 3-4 is performed again. Further, in the case where the continued transformation is judged to be unnecessary, the investigation is completed, and the glass sheet is judged to be satisfactory.

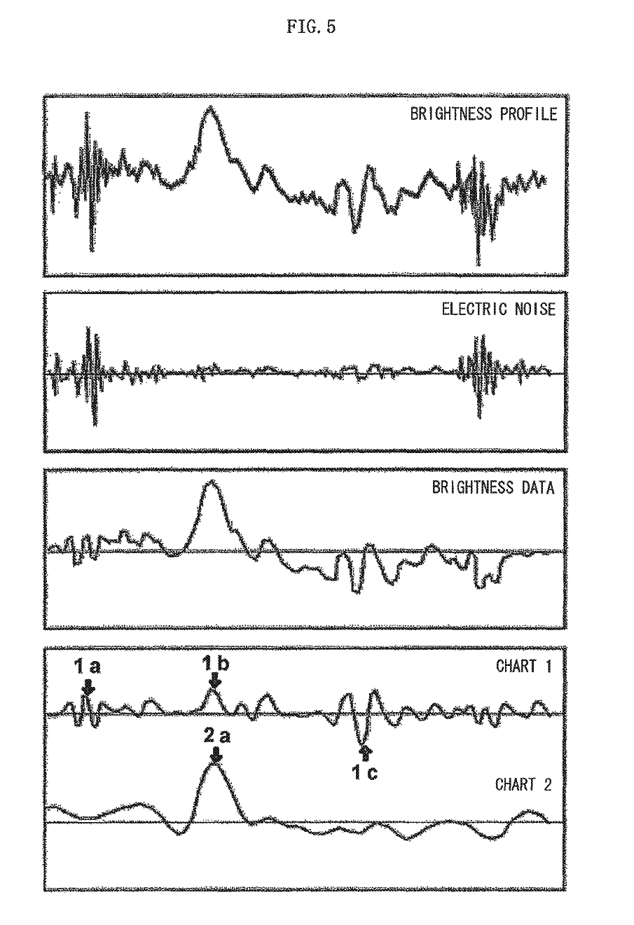

FIG. 5 illustrates a chart and the like of the above-mentioned processing of brightness data. In FIG. 5, an “electric noise” component is removed from the “brightness profile” obtained form the light reception device 30, whereby “brightness data” is obtained. Then, a component with a short frequency obtained by subjecting the “brightness data” to Fourier transformation is illustrated in “Chart 1”. Herein, defective portions 1a, 1b, and 1c are detected from the upper and lower limit values of “Chart 1”. A component with a long frequency is similarly illustrated in “Chart 2”. A defective portion 2a was detected from the upper and lower limit values of “Chart 2”.

Further, Table 1 shows an example of the judgment standard in the case of judging products to be satisfactory or poor. As shown in Table 1, a plurality of window functions are set, and the quality is judged totally based on the combination of the respective judgment results, whereby further detailed judgment of the quality can be made.

TABLE 1

| | Chart 1 in | Chart 2 in | Chart 3 in | |
|---|---|---|---|---|
| Con- | window | window | window | Final |
| dition | function 1 | function 2 | function 3 | judgment |
| 1 | Defective | — | — | Discard as |
| | portion found | | | defective |
| 2 | — | Defective | Defective | Discard as |
| | | portion found | portion found | defective |
| 3 | — | At least two | — | Discard as |
| | | defective | | defective |
| | | portions found | | |
| 4 | — | One defective | No defective | B-class |
| | | portion found | portion found | product |
| 5 | — | No defective | Defective | B-class |
| | | portion found | portion found | product |

| | | |
|---|---|---|
| 6 | Not complying with conditions 1 to 5 | Satisfactory |
| | | product |

The above-mentioned glass sheet defect detection program can be stored in an appropriate medium such as an HDD, a DVD, a CD-ROM, or a flush memory, and the operation of a program may be changed if the program is required to be performed in synchronization with another system Further, the above-mentioned glass sheet defect detection program can be described using appropriate program languages such as C++ and C.

Then, a glass sheet inspection method of the present invention is described by way of an example of a method of inspecting a glass sheet to be mounted on a liquid crystal display device.

The light-transparent surface of a liquid crystal display device corresponds to a surface on which an image is to be displayed when mounted on a liquid crystal display device. Therefore, the surface with defects recognizable with naked eyes cannot be accepted. Therefore, the inspection with naked eyes is mainly considered to be important as this type of inspection. The glass sheet inspection method of this example can be replaced by the inspection with naked eyes, and can also be adopted for the purpose of supplementing the inspection with naked eyes.

When a thin glass sheet for liquid crystal to be inspected is transported, the thin glass sheet is inspected with the irradiation of the light ray L from the light source 20 (metal halide lamp) in the light reception device 30 (line sensor) while the thin glass sheet is moved in a direction parallel to the light-transparent surface as described above. In the case where the light ray L from the light source 20 is received with respect to the length of 2000 mm, in the width direction of the glass sheet, it is preferred to set a sampling frequency in accordance with the transportation speed of the glass sheet. Thus, a system equipped with a processing system for changing a sampling of the inspection depending upon the forming speed of the glass sheet can be obtained.

Further, the glass sheet with a predetermined film formed on the surface thereof can also be subjected to a final inspection, and consequently, a high inspection quality can be realized with respect to a product with a film in the case of a glass sheet for a plasma display and the like.

As described above, the glass sheet defect detection device, glass sheet manufacturing method, glass sheet defect detection judging program, and the glass sheet inspection method in this example can all greatly contribute to the manufacturing of various kinds of glass sheets along with the appropriate judging of the quality of the glass sheets in the process, for manufacturing excellent glass sheets.

### Example 2

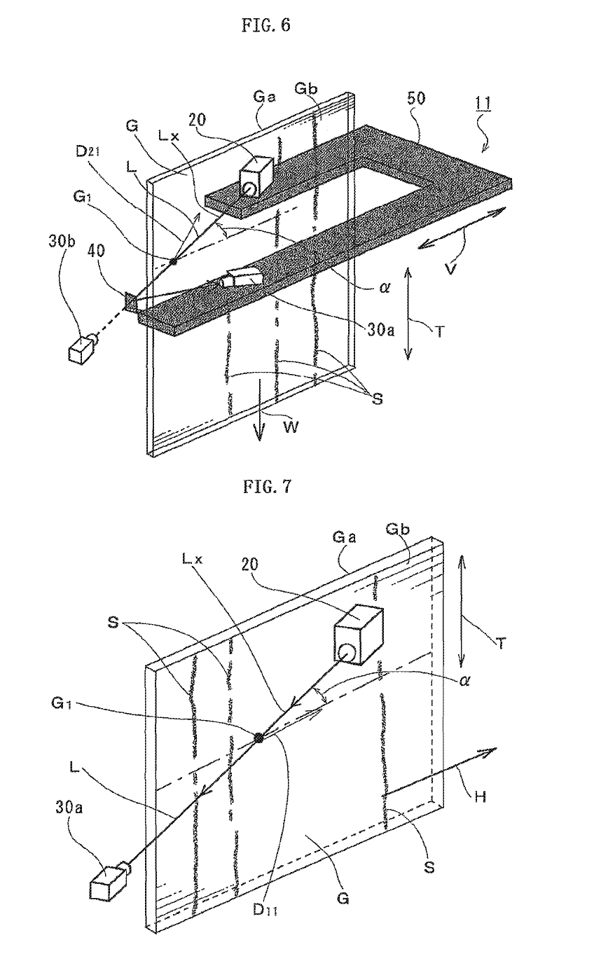

Next, a glass sheet defect detection device 11 according to Example 2 is described specifically with reference to FIG. 6. The glass sheet detection device 11 is configured so as to measure, for example, a thin glass sheet G with a width of 1500 mm and a thickness of 0.65 mm to be mounted on a TFT liquid crystal display device continuously with a space saved. FIG. 6 schematically illustrates the configurations of main portions of the glass sheet defect detection device 11 and illustrates that the glass sheet G is extracted continuously downward by heat-resistant rolls (not shown) after being formed from a glass melting furnace from an upper side to a lower side. W in the figure indicates the movement direction of the glass sheet G.

The glass sheet defect detection device 11 includes a light source 20, and a light reception device 30a, and a reflective mirror 40 placed so as to sandwich the glass sheet G. For example, a metal halide lamp is used as the light source 20, and the light reception device 30a has a solid imaging element. The light source 20, the light reception device 30a, and the reflective mirror 40 are attached to an inspection stage 50 movable in a V direction in the figure, and a light ray L radiated from the light source 20 passes through the glass plate G to enter the reflective mirror 40, and is reflected by the reflective mirror 40 to enter the light reception device 30a. The glass plate G has light-transparent surfaces Ga, Gb opposed to each other in the thickness direction, and is placed between the light source 20 and the light reception device 30a so that the light-transparent surfaces Ga, Gb are inclined at a predetermined angle α with respect to a light axis Lx (line connecting the centers of a series of optical elements constituting the optical system from the light source 20 to the light reception device 30a) of an optical system of the glass sheet defect detection device 11. The distance from the light source 20 to a position G1 of the glass plate G is set to be 1000 mm the distance from the position G1 of the glass plate G to the reflective mirror 40 is set to be 500 mm, and the distance from the reflective mirror 40 to the solid imaging element of the light reception device 30a is set to be 500 mm on the light axis Lx. The focal length of the lens system of the light reception device 30a is 700 mm. Thus, on the light axis Lx, the focal length 700 mm of the lens system of the light reception device 30a is smaller than the distance 1000 mm (=500 mm+500 mm) from the light reception device 30a to the position G1. of the glass plate G. Further, an angle α formed by the light-transparent surfaces Ga, Gb of the glass sheet G and the light axis Lx is 20°.

According to the inspection by the glass sheet defect detection device 11, an inspection stage 50 is moved at a movement speed of 500 mm/s so as to be in parallel to the light-transparent surfaces Ga, Gb of the glass sheet G in a scanning direction V perpendicular (90°) to an extraction forming direction (movement direction W) of the glass sheet G, whereby the glass sheet G is measured in 3 seconds. Various kinds of defects S such as waves caused by striae present on the surface of and inside the glass sheet G and the unevenness of the surface are mostly distributed so as to be stretched during forming of glass sheet or to be continued in the same direction T as the extraction forming direction (movement direction W) of the glass sheet by the forming device and the like in contact with the surface of the glass. Therefore, a direction D₂₁ In which sites to be inspected of the glass sheet G are scanned is a direction obtained by combining the extraction forming speed (movement speed in the movement direction W) of the glass sheet G and the scanning speed in the scanning direction V of the inspection stage 50, and scanning is performed in a range of, for example, 80° to 84° with respect to the continued direction T of the defects. For example, the solid imaging element mounted on the light reception device 30a is a CMOS containing 2000 pixels, and the transfer speed of the light reception device 30 is 20 MHz. Therefore, the image capturing speed is 10000 times/sec., and 30000 sampling data per 0.05 am can be used for judging the quality of the glass sheet G.

Further, the glass sheet defect detection device 11 uses the reflective mirror 40 so as to be configured to be compact in general in order to be placed even in a small measurement environment, and this allows the glass sheet defect detection device 11 to exhibit a high inspection ability even in a small inspection environment. Thus, in an environment capable of keeping a sufficient space, the light reception device 30b with a solid imaging element is used instead of the light reception device 30a, and measurement may be performed without using the reflective mirror 40. The light reception device 30b is placed at a position opposed to the light source 20 with the glass sheet G interposed therebetween.

### Example 3

Further, FIG. 7 illustrates a conceptual view regarding a glass sheet defect detection device with another configuration. In the glass sheet defect detection device, the distance from the light source 20 to the position G1 of the glass sheet G is set to be 1000 mm, and the distance from the position G1 of the glass sheet G to the solid imaging element of the light reception device 30a is set to be 1000 mm on the light axis Lx. The focal length of the lens system of the light reception device 30a is 700 mm. Thus, on the light axis Lx, the focal length 700 mm of the lens system of the light reception device 30a is smaller than the distance 1000 mm from the light reception device 30a to the position G1 of the glass sheet G. Further, the angle αformed by the light-transparent surfaces Ga, Gb of the glass sheet G and the light axis Lx is 20°.

The glass sheet defect detection device is configured so as to perform measurement when moving the cut glass sheets G one by one. The glass sheet S moves in an H direction (horizontal direction) illustrated in FIG. 7, and the movement direction H is perpendicular to the direction T in which the surface defects and the like of the glass sheet G are continued. More specifically, measurement is performed while the glass sheet G is moved in the perpendicular direction H and the direction T in which the defects of the glass sheet G are continued. Therefore, scanning is performed under the condition that a direction D₁₁ in which the sites to be inspected of the glass sheet G is in a range of 89° to 90° with respect to the direction in which the continued streak-shaped surface defects S are aligned.

Due to such measurement, the quality of the glass sheets G can be judged exactly one by one, and the glass sheets can be selected previously so that the maximum defect size is less than 0.1 μm. Therefore, a glass sheet of stable quality can be obtained easily at low cost.

### BRIEF DESCRIPTION OF THE DRAWINGS

[FIG. 1] A conceptual explanatory view regarding a scanning direction of a glass sheet defect detection device of the present invention.

[FIG. 2] Explanatory views of a glass sheet defect detection device according to an example: (A) is a schematic view of the device and (B) is a conceptual view of an optical system.

[FIG. 3] A conceptual view illustrating a system configuration of the glass sheet defect detection device according to the example.

[FIG. 4] A flowchart illustrating a processing system of a glass sheet defect detection judging program according to the example.

[FIG. 5] Charts obtained from brightness data processing and the like of the glass sheet defect detection judging program according to the example.

[FIG. 6] An explanatory view of a system configuration of glass sheet defect detection device according to another example.

[FIG. 7] An explanatory view of a system configuration of a glass sheet defect detection device according to another example.

### DESCRIPTION OF SYMBOLS

10, 11 glass sheet defect detection device
20 light source
21 position of light source
30, 30a, 30b light reception device
31 lens system of light reception device
40 reflective mirror
50 inspection stage
D₁, D₁₁, D₂, D₃, D₂₁ direction of scanning site to be inspected
D₄ direction of not scanning site to be inspected
G glass sheet
G₁ position on light axis of glass sheet
Ga, Gb light-transparent surface of glass sheet
L light ray
Lx light-axis
α angle formed by light-transparent surface of glass sheet and light axis
F focal length of light reception device
S defects of glass sheet
T longitudinal direction of continued defects
V movement direction of inspection stage
W, H movement direction of glass sheet
Z distance from glass sheet to light reception device
1a, 1b, 1c defective portion detected from Chart 1
2a defective portion detected from Chart 2

1. A glass sheet defect detection device in which a glass sheet having light-transparent surfaces opposed to each other in a thickness direction is irradiated with a light ray from a light source, and the light ray from the glass sheet is received by a light reception device to detect defects of the glass sheet, wherein:
the light source and the light reception device are placed with the glass sheet being interposed therebetween;
the light-transparent surfaces of the glass sheet are inclined with respect to a light axis of an optical system from the light source to the light reception device;
a focal length of a lens system of the light reception device is smaller than a distance from a light reception element of the light reception device to the glass sheet on the light axis; and
one of the light-transparent surfaces of the glass sheet is irradiated with the light ray from the light source, and the light ray transmitted through the glass sheet is received by the light reception element through the lens system of the light reception device.

2. A glass sheet defect detection device according to claim 1, wherein an inclination angle of the light-transparent surfaces of the glass sheet with respect to the light axis is in a range of 5° to 40°.

3. A glass sheet defect detection device according to claim 1, wherein a solid imaging element or a photoelectric detector is mounted as the light reception element on the light reception device.

4. A glass sheet defect detection device according to claim 1, wherein:
the defects of the glass sheet have a continued shape in a predetermined direction; and
sites to be inspected of the glass sheet are scanned with the light ray from the light source in a direction crossing a direction in which the defects are continued.

5. A glass sheet defect detection device according to claim 1, comprising:
a storage device that stores information on the light ray received by the light reception device; and
a data display portion that displays the information on a display.

6. A glass sheet defect detection device according to claim 1, wherein the glass sheet is a thin glass sheet to be mounted on a display device.

7. A glass sheet manufacturing method of inspecting defects on a surface and/or inside a glass sheet formed by a forming device after heat-melting, followed by cooling, with the glass sheet defect detection device according to claim 1, thereby judging quality.

8. A glass sheet manufacturing method according to claim 7, wherein the forming device is a down draw forming device or a float forming device.

9. A glass sheet manufacturing method according to claim 8, wherein the glass sheet is a glass sheet for a liquid crystal display or a glass sheet for a plasma display.

10. A glass sheet manufactured by the glass sheet manufacturing method according to claim 7 which is made of alkalifree glass and has a thickness of 0.7 mm or less and a maximum defect size of less than 0.1 μm.

11. A glass sheet quality judging device, comprising:
a measurement means for irradiating a glass sheet with a light ray from a light source and receiving the light ray from the glass sheet by a light reception device;
a chart acquiring means for subjecting a brightness profile of an image obtained by the measurement means to Fourier transformation or wavelet transformation to obtain a processing result chart; and
an algorithm processing system of evaluating defects of the glass sheet based on the processing result chart to judge quality.

12. A glass sheet quality judging device according to claim 11, wherein the algorithm processing system combines at least two processing result charts and makes a final judgment of quality based quality results obtained from upper and lower limit values of the respective processing result charts.

13. A glass sheet defect detection device according to claim 2, wherein a solid imaging element or a photoelectric detector is mounted as the light reception element on the light reception device.

14. A glass sheet defect detection device according to claim 2, wherein:
the defects of the glass sheet have a continued shape in a predetermined direction; and
sites to be inspected of the glass sheet are scanned with the light ray from the light source in a direction crossing a direction in which the defects are continued.

15. A glass sheet defect detection device according to claim 3, wherein:
the defects of the glass sheet have a continued shape in a predetermined direction; and
sites to be inspected of the glass sheet are scanned with the light ray from the light source in a direction crossing a direction in which the defects are continued.

16. A glass sheet defect detection device according to claim 13, wherein:
the defects of the glass sheet have a continued shape in a predetermined direction; and
sites to be inspected of the glass sheet are scanned with the light ray from the light source in a direction crossing a direction in which the defects are continued.

17. A glass sheet defect detection device according to claim 2, comprising:
a storage device that stores information on the light ray received by the light reception device; and
a data display portion that displays the information on a display.

18. A glass sheet defect detection device according to claim 3, comprising:
a storage device that stores information on the light ray received by the light reception device; and
a data display portion that displays the information on a display.

19. A glass sheet defect detection device according to claim 13, comprising:
a storage device that stores information on the light ray received by the light reception device; and
a data display portion that displays the information on a display.

20. A glass sheet defect detection device according to claim 4, comprising:
a storage device that stores information on the light ray received by the light reception device; and
a data display portion that displays the information on a display.
